(19) United States
(12) Patent Application Publication
(10) Pub. No.: US 2013/0304310 A1
(43) Pub. Date: Nov. 14, 2013

(54) FAIL-SAFE CONTROL SYSTEM FOR VEHICLE

(71) Applicant: DENSO CORPORATION, Kariya-city (JP)

(72) Inventors: Kimiyo INADA, Kariya-city (JP); Akio KAMIYA, Okazaki-city (JP)

(73) Assignee: DENSO CORPORATION, Kariya-city (JP)

(21) Appl. No.: 13/890,761

(22) Filed: May 9, 2013

(30) Foreign Application Priority Data
May 14, 2012 (JP) 2012-110508

(51) Int. Cl. G07C 5/00

(52) U.S. Cl. CPC G07C 5/006
USPC 701/31.9

(57) ABSTRACT

A data communication system has a pair of signal lines which connects a plurality of controllers on a vehicle. At least one controller has a failure detector which detects data communication failure. At least one controller has a fall-back detector which detects fall-back state in which data communication is performed by using only one signal line. At least one controller has a high-level fail-safe module which restricts driving of the vehicle in response to a detection of the failure. The controller also has a low-level fail-safe module which performs precautious fail-safe control, which is less restrictive than that performed by the high-level fail-safe module, in response to a detection of the fall-back state.

### CROSS REFERENCE TO RELATED APPLICATION

This application is based on Japanese Patent Application(s) No. 2012-110508 filed on May 14, 2012, the disclosure of which is incorporated herein by reference.

### TECHNICAL FIELD

The present disclosure relates to a fail-safe control system for vehicle applied to a data communication system which connects controllers via signal lines.

### BACKGROUND

JP2003-304265A discloses a data communication system for vehicle. The system utilizes differential voltage signaling on a pair of signal lines which is provided on the vehicle for connecting a plurality of controllers in a data communication manner. Such a system may be known as a local network protocol such as CAN (Controller Area Network) (Trademark).

### SUMMARY

The signal lines on the vehicle may be damaged due to vibration etc. and may create an open circuit and a short circuit. When one of the signal lines is damaged, CAN system still enables data communication by using the remaining other one of signal line. However, if both signal lines are damaged, data communication would be completely stopped and in failure mode. The system in JP2003-304265A restores a signal line, which is not damaged, to available state by using a back-up terminal resistor, when the system once becomes failure in which data communication is completely disabled or unavailable.

Even if the system may be restored in this way, still there may be a case in which it is impossible to drive the vehicle, depending on a damaged part. In this case, it is impossible to drive the vehicle to a repair yard. Therefore, it is desirable to perform fail-safe control before data communication becomes complete failure. For this purpose, it is desirable to detect an omen of failure in an early stage of failure.

It is an object of present disclosure to provide a fail-safe control system which is capable of performing a fail-safe control by detecting an omen of failure in an early stage of failure.

According to the present disclosure, a fail-safe control system for vehicle is provided. The control system is used for a vehicular data communication system which uses differential voltage signaling on a pair of signal lines for connecting a plurality of controllers in a data communication manner. The control system comprises a failure detector which detects that data communication on the communication system is in failure state. The control system comprises a fall-back detector which detects that data communication on the communication system is in fall-back state in which data communication is performed by using a single signal line when the other signal line is damaged. The control system comprises a high-level fail-safe module which restricts function of the vehicle when the failure detector detects the failure state. The control system comprises a low-level fail-safe module which restricts function of the vehicle with a different level of restriction or notifies the fall-back state to a passenger on the vehicle, when the fall-back detector detects the fall-back state.

The differential voltage signaling on a pair of signal lines can enable data communication by using a single signal line even if one of the signal lines is damaged. This state may be one example of fall-back state. However, if the system is kept in the fall-back state, it is highly probable that data communication falls into failure state since the other signal line may be also damaged soon. Therefore, the fall-back state can be used as one example of omens of failure.

According to the disclosure, since the low-level fail-safe module performs the fail-safe control in response to the fall-back state, it is possible to encourage the user to repair the vehicle.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing a data communication system with a fail-safe control system according to the present disclosure;

FIG. 2 is a diagram showing fall-back detecting algorithm based on number of data communication errors;

FIG. 3 is a diagram showing modes of failure and fall-back state detectable based on voltage levels on signal lines;

FIG. 4 is a diagram showing voltage levels in a normal state;

FIG. 5 is a diagram showing voltage levels in one of modes;

FIG. 6 is a diagram showing voltage levels in one of modes;

FIG. 7 is a diagram showing voltage levels in one of modes;

FIG. 8 is a flow chart showing an example of fail-safe controls performed in one of controllers;

FIG. 9 is a flow chart showing an example of fail-safe controls performed in one of controllers; and

FIG. 10 is a diagram showing blocks corresponding to detectors and modules.

### DETAILED DESCRIPTION

A fail-safe control system according to an embodiment of the disclosure is described referring to the drawings.

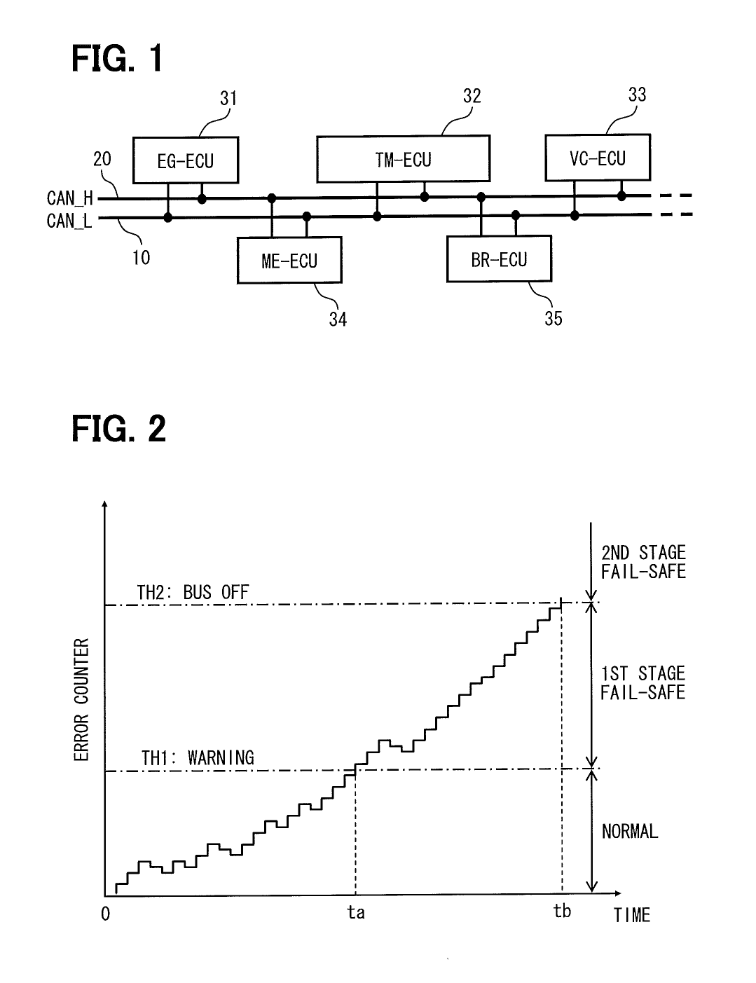

FIG. 1 shows a data communication system which is mounted on a vehicle. The system has a pair of signal lines 10 and 20. The signal lines 10, 20 are terminated by a terminal resistor, not illustrated. The system connects a plurality of devices 31, 32, 33, 34, and 35 as nodes in a data communication manner. The signal line 10 is provided as a low-voltage side line, hereinafter referred to as CAN_L. The signal line 20 is provided as a high-voltage side line, hereinafter referred to as CAN_H. The devices 31-35 are adapted to performed data communication by using the differential voltage signaling among them. The devices 31-35 provides controllers to perform function of the vehicle.

The device 31 is an engine ECU (Electronic Control Unit) (EG-ECU) which controls an operation of an internal combustion engine (engine) mounted on the vehicle as a driving power source. The device 32 is a transmission ECU (TM-ECU) which controls an operation of a transmission disposed between the engine and a driven wheel. TM-ECU 32 controls speed reduction ratio of the transmission. The device 33 is a vehicle distance control ECU (VC-ECU) which detects a distance to a traffic ahead and the vehicle, and performs automatic control of braking or engine output. VC-ECU 33 may be configured to keep the vehicle at a distance from the traffic ahead. The device 34 is a meter ECU (ME-ECU) which controls an operation of a meter which displays vehicle operation states, such as driving speed of the vehicle. The device 35 is a brake control ECU (BR-ECU) which controls a brake operation, i.e., modulates brake pressure, to prevent wheel lock.

CAN_L 10 and CAN_H 20 are covered within a common covering material and shielding material (not shown) to provide a bus cable. As shown in FIG. 4, CAN_L 10 is a signal line which transmits signal of 1.6V-2.5V, i.e., L-signal. CAN_H 20 is a signal line which transmits signal of 2.5V-3.4V, i.e., H-signal. In FIGS. 4-7, the vertical axis shows signal voltage Vs.

Each device 31-35 performs data communication by using protocol for the differential voltage signaling, e.g., CAN. In the differential voltage signaling, “0” is transmitted by a low level in which a differential voltage between L-signal and H-signal is less than a predetermined threshold. “1” is transmitted by a high level in which a differential voltage between L-signal and H-signal is equal to or higher than the predetermined threshold. Therefore, if the differential voltage is 0V, it is determined that the signal is the low level recessive signal. On the other hands, if the differential voltage is 1.8V, it is determined that the signal is the high level dominant signal.

FIG. 2 shows one of fall-back detector which detects fall-back state based on counted number of errors in data communication. At least one of the devices 31-35 has an error counter. The error counter is incremented in response to error detection in data communication. The error counter is decremented in response to correct, i.e., normal, data communication. Therefore, the error counter detects a frequency of error in data communication. The error may be detected by using the known error detection method, such as the CRC check error, the form check error, the ACK error, the bit error, the staff error, etc.

Damage on the bus cable may be a cause of these errors. For example, an external member may come in contact with the bus cable, and may damage the bus cable by vibration of the vehicle. In this case, first, one of CAN_L 10 and CAN_H 20 is damaged, then, the other one of CAN_L 10 and CAN_H 20 is damaged later. That is, both CAN_L 10 and CAN_H 20 rarely reach failure state simultaneously. In many cases, as damage on the bus cable progresses, first, one of the lines reaches failure, then, the other line reaches failure.

Moreover, there may be the following failure modes, such as GND short circuit, +B short circuit, and an open circuit. In a mode of GND short circuit, CAN_L 10 or CAN_H 20 comes in contact with an external member which has potential similar to the ground. In this mode, L-signal or H-signal is fixed on the ground level, such as 0V. In a mode of +B short circuit, CAN_L 10 or CAN_H 20 comes in contact with an external member which has potential similar to the positive side of the electric power source. In this mode, L-signal or H-signal is fixed on the power source level, such as 5V. In a mode of open circuit, CAN_L 10 or CAN_H 20 is disconnected. In this case, L-signal or H-signal is changed with an unfixed value.

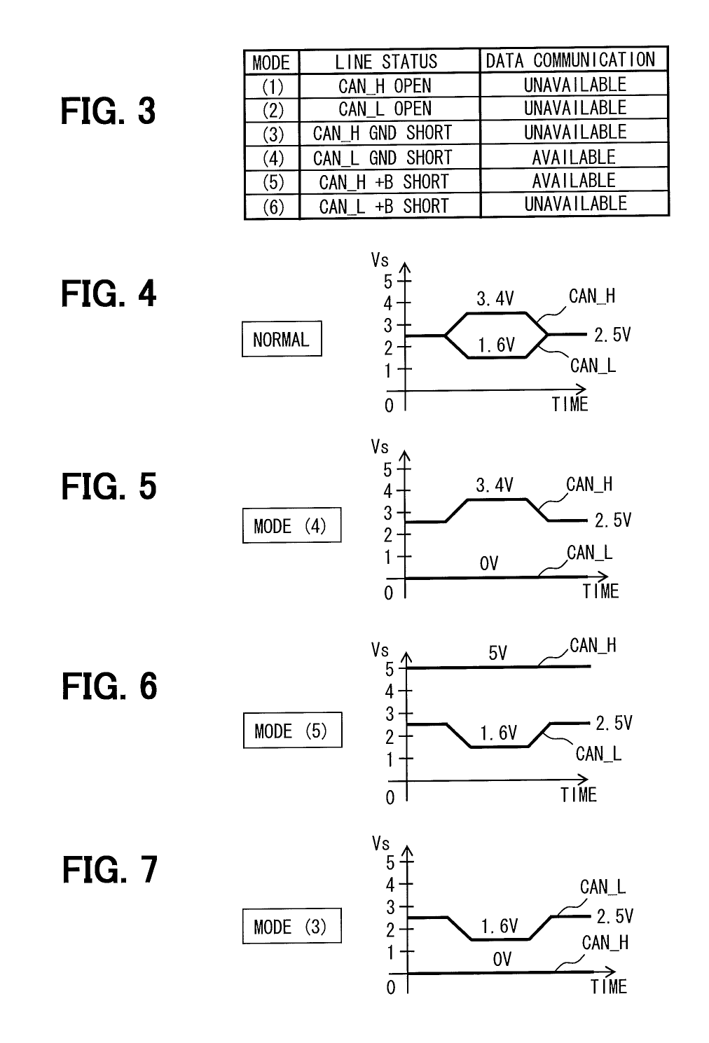

FIG. 3 shows a table of the modes and availability of data communication. In certain modes, i.e., mode (1), (2), (3) and (6), data communication is not available. However, in certain modes, i.e., mode (4) and (5), data communication is still available.

As shown in the mode (4) and FIG. 5, even if CAN_L 10 is in the GND short circuit and L-signal is fixed at 0V, the differential voltage is still responsive between 2.5V and 3.4V in response to H-signal which is still in normal. Therefore, it is possible to determine between low level “0” and high level “1”, and to perform data communication.

As shown in the mode (5) and FIG. 6, even if CAN_H 20 is in +B short circuit and H-signal is fixed at 5V, the differential voltage is still responsive between 2.5V and 3.4V in response to L-signal which is still in normal. Therefore, it is possible to determine between low level “0” and high level “1”, and to perform data communication.

As shown in the mode (3) and FIG. 7, if CAN_H 20 is in GND short circuit and H-signal is fixed at 0V, the differential voltage is responsive between −2.5V and −1.6V in response to L-signal which is still in normal. In this case, the differential voltage becomes abnormal value outside a normal range. Therefore, it is impossible to determine between low level “0” and high level “1”, and to perform data communication.

The state in which data communication is available by using a single signal line while the other signal line is damaged and shows abnormal value is referred to as fall-back state. The modes (4) and (5) correspond to the fall-back state. The state in which data communication is unavailable is referred to as failure state. The modes (1), (2), (3) and (6) correspond to the failure state.

If one of CAN_L 10 and CAN_H 20 is damaged and the system turned into the fall-back state, data communication is still available, but if the system is kept in the fall-back state, it is highly probable that data communication falls into the failure state since the other signal line may be also damaged soon. This means that the fall-back state is an omen of the failure state.

In this embodiment, the fail-safe system is configured to perform a high-level fail-safe control, which is highly restrictive to function of the vehicle, in response to the failure state. The high-level fail-safe control may inhibit driving of the vehicle. The fail-safe system is configured to perform a low-level fail-safe control, which is less restrictive to the function of the vehicle than the high-level fail-safe control, in response to the failure state. The low-level fail-safe control may enables driving of the vehicle while restricting driving function of the vehicle. In addition or alternatively, the low-level fail-safe control may notify the user that the data communication is in the fall-back state.

Referring to FIG. 2, the fail-safe system is configured to allow a normal control during a number of the error counter is less than a first threshold TH1. The fail-safe system is configured to perform a first stage fail-safe, i.e., a first fail-safe control, when the number of the error counter exceeds the first threshold TH1 and is less than the second threshold TH2. The fail-safe system is configured to perform a second stage fail-safe, i.e., a second fail-safe control, when the number of the error counter exceeds the second threshold TH2.

In the first fail-safe control, the fail-safe system still allows one of function of the vehicle in a restricted performance. In the second fail-safe control, the fail-safe system restricts the function in a more restrictive manner than the first fail-safe control. For example, traveling, i.e., driving, function of the vehicle may be inhibited in the second fail-safe control. But the traveling function may be still available in the first fail-safe control in a less restrictive manner than the second fail-safe control. For example, function for keeping distance from traffic ahead may be inhibited in the second fail-safe control. In other words, the driver cannot use the function in the second fail-safe control. But the distance keeping function may be still available in the first fail-safe control in a less restrictive manner than the second fail-safe control. A distance from traffic ahead may be controlled longer than normal state. In other words, the driver can use the function in the first fail-safe control.

For this purpose, the fail-safe system has a module or section which detects error on data communication and counts the frequency of the error. The fail-safe system has a module or section which evaluates and determines that whether the number of the error counter exceeds the first threshold TH1 or not. When the number exceeds TH1, the fail-safe system determines that it is in the fall-back state, and sets a flag fail1 to “ON”. Then, the fail-safe system performs the low-level fail-safe. The fail-safe system has a module or section which evaluates and determines that whether the number of the error counter exceeds the second threshold TH2 or not. When the number exceeds TH2, the fail-safe system determines that it is in the failure state, and sets a flag fail2 to “ON”. Then, the fail-safe system performs the high-level fail-safe. The second threshold TH2 is set higher than the first threshold TH1.

Referring to FIGS. 3-7, the fail-safe system is configured to allow a normal control during the differential voltage is in a normal range as shown in FIG. 4. The fail-safe system is configured to perform a first stage fail-safe, i.e., a first fail-safe control, when the voltage levels on CAN_L and CAN_H becomes the mode (4) or (5). The fail-safe system is configured to perform a second stage fail-safe, i.e., a second fail-safe control, when voltage levels on CAN_L and CAN_H becomes the mode (1), (2), (3) or (6).

For this purpose, the fail-safe system has a module or section which detects voltage levels of L-signal and H-signal. The fail-safe system has a module or section which evaluates and determines that whether the voltage levels show the mode (4) or (5). When the voltage levels are in the modes (4) or (5), the fail-safe system determines that it is in the fall-back state, and sets the flag fail1 to “ON”. Then, the fail-safe system performs the low-level fail-safe. The fail-safe system has a module or section which evaluates and determines that whether the voltage levels show the mode (1), (2), (3) or (6). When the voltage levels are in the mode (1), (2), (3) or (6), the fail-safe system determines that it is in the failure state, and sets the flag fail2 to “ON”. Then, the fail-safe system performs the high-level fail-safe. The fail-safe system performs the high-level fail-safe when one of the voltage levels is fixed at 0V or 5V, or is not in a predetermined normal range.

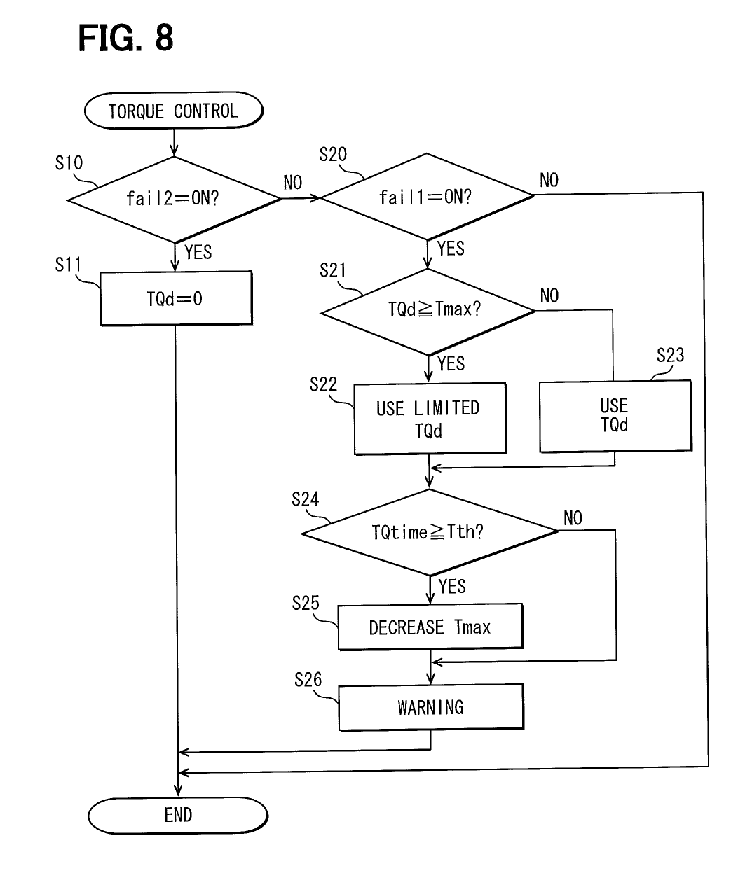

FIG. 8 is a flow chart showing process for performing the high-level fail-safe and the low-level fail-safe in a torque control performed by EG-ECU 31. In this embodiment, the fail-safe system is mainly provided by EG-ECU 31. EG-ECU 31 provides function to control the engine to output torque corresponding to a target torque TQd. In S10 and S20, EG-ECU 31 determines that whether the flag fail1 or flag fail2 is set “ON” or not. S10 provides a failure detector. S20 provides a fall-back detector.

When it is determined that the fail2 is “ON”, the process branches to YES from S10. In S11, EG-ECU 31 performs the high-level fail-safe. S11 provides a high-level fail-safe module. In S11, EG-ECU 31 fixes a target torque TQd in a predetermined value “TQd=0” regardless of an operated amount of a gas pedal by a driver of the vehicle, i.e., a value of an engine output demanded by the driver. In other words, EG-ECU 31 at least inhibits an acceleration of the vehicle. The predetermined value “TQd=0” may be set at a value corresponding to an idling of the engine, for example. Alternatively, in S11, EG-ECU 31 may stop the engine forcedly. Alternatively, in S11, EG-ECU 31 may inhibit driving of the vehicle.

When it is determined that the fail1 is “ON”, the process branches to YES from S20. In S21, EG-ECU 31 determines that whether the operated amount of the gas pedal, i.e., the target torque TQd, is equal to or higher than a predetermined value Tmax. The predetermined value Tmax may be referred to as a maximum value or a guard value to restrict the engine output torque. If the target torque TQd is less than the predetermined value Tmax (TQd<Tmax), the process branches to NO from S21. In S23, EG-ECU 31 controls the engine to adjust output torque based on the target torque TQd demanded by the driver.

If the target torque TQd is equal to or higher than the predetermined value Tmax (TQd>Tmax or TQd=Tmax), the process branches to YES from S21. In S22, EG-ECU 31 performs the low-level fail-safe. S22 provides a low-level fail-safe module. In S22, EG-ECU 31 controls the engine to adjust output torque at a predetermined value Tmax by restricting the target torque TQd to the predetermined value Tmax. In other words, the target torque is limited at the predetermined value Tmax. That is, EG-ECU 31 enables an acceleration of the vehicle while restricting the engine output not to exceed the predetermined value Tmax.

In S24, EG-ECU 31 determines that whether a time TQtime is equal to or longer than a predetermined time Tth or not. TQtime is a period in which the driver continuously demands torque by operating the gas pedal. Therefore, in S24, EG-ECU 31 determines that whether the driver continuously demands toque increase longer than the predetermined time Tth or not. If TQtime is equal to or longer than Tth (TQtime>Tth or TQtime=Tth), the process branches to YES from S24. In S25, EG-ECU 31 decreases the predetermined value Tmax to make the low-level fail-safe more restrictive, i.e., to reduce the engine output. In S26, EG-ECU 31 notifies the user of the vehicle that the data communication is in the fall-back state. The notification may be provided by turning on a warning lamp or turning on a warning buzzer. S26 also provides the low-level fail-safe module. S26 provides a notifying module which does not restrict function of the vehicle but notifies the user the fall-back state.

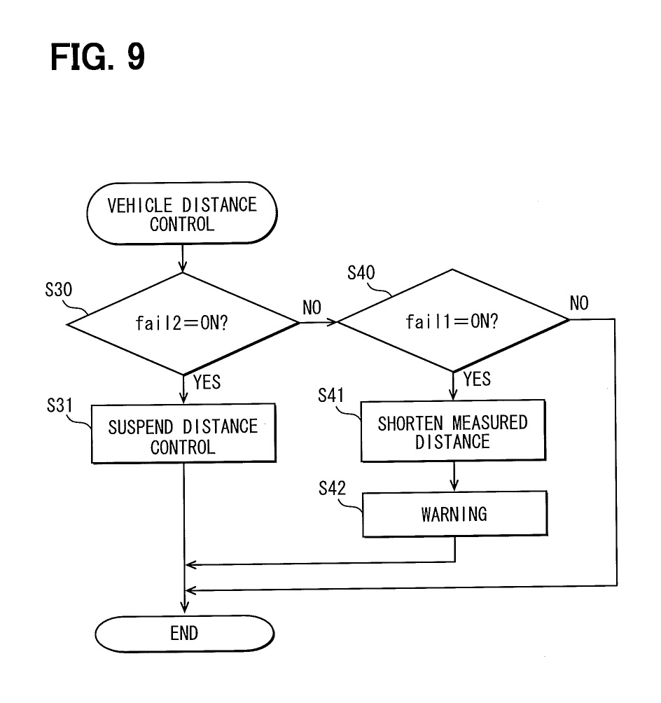

FIG. 9 is a flow chart showing process for performing the high-level fail-safe and the low-level fail-safe in a vehicle distance control performed by VC-ECU 33. In this embodiment, the fail-safe system is mainly provided by VC-ECU 33. VC-ECU 33 provides function to keep a preferable distance between the vehicle and traffic ahead. VC-ECU 33 automatically controls the engine output or braking amount in accordance with a distance between the vehicle and the traffic ahead detected by a distance sensor.

In S30 and S40, VC-ECU 33 determines that whether the flag fail1 or flag fail2 is set “ON” or not. S30 provides a failure detector. S40 provides a fall-back detector.

When it is determined that the fail2 is “ON”, the process branches to YES from S30. In S31, VC-ECU 33 performs the high-level fail-safe. S31 provides a high-level fail-safe module. The high-level fail-safe suspends the function of the vehicle, i.e., suspends the distance control. When it is determined that the fail1 is “ON”, the process branches to YES from S40. In S41, VC-ECU 33 performs the low-level fail-safe. S41 provides a low-level fail-safe module. The low-level fail-safe corrects a distance, and enables to perform the distance control based on the corrected distance. The low-level fail-safe shorten a measured distance detected by the distance sensor, and performs the distance control based on the shortened measured distance. In S42, VC-ECU 33 notifies the user of the vehicle that the data communication is in the fall-back state. The notification may be provided by turning on a warning lamp or turning on a warning buzzer. S42 also provides the low-level fail-safe module. S42 provides a notifying module which does not restrict function of the vehicle but notifies the user the fall-back state.

According to the embodiment, the fail-safe system performs the low-level fail-safe in response to detection of the fall-back state. The low-level fail-safe is less restrictive than the high-level fail-safe in the failure state. The low-level fail-safe restricts driving performance of the vehicle (S22, S41) and notifies the user the fall-back state (S26, S42). Therefore, the user can recognize abnormal condition of the fall-back state during the user is still enabled to drive the vehicle by the low-level fail-safe, prior to the failure state, it is possible to encourage the user to drive to repair the vehicle. It is possible to remove disadvantages in which the user cannot drive the vehicle to repair if the high-level fail-safe is performed without performing prior precautious low-level fail-safe.

According to embodiment, the fail-safe system detects the fall-back state based on the voltage levels on CAN_L 10 and CAN_H 20 as shown in FIG. 3. In addition, the fail-safe system detects the fall-back state based on the number of error on the data communication system as shown in FIG. 2. Therefore, it is possible to detect the fall-back state with high accuracy.

It is possible to detect the fall-back state promptly in a case that the fall-back state is detected based on the voltage levels compared with a case in which the fall-back state is detected based on the number of errors. On the other hand, it is possible to detect the fall-back state without setting or using sensors for detecting the voltage levels in a case that the fall-back state is detected based on number of errors.

According to the embodiment, the high-level fail-safe inhibits driving of the vehicle or inhibits an acceleration of the vehicle, therefore, it is possible to prevent disadvantages which may occur in the failure state. According to the embodiment, the low-level fail-safe enables the user to drive the vehicle under a restricted engine output at the predetermined value Tmax, therefore, it is possible to allow the driver to drive the vehicle to repair while preventing disadvantages which may occur in the fall-back state.

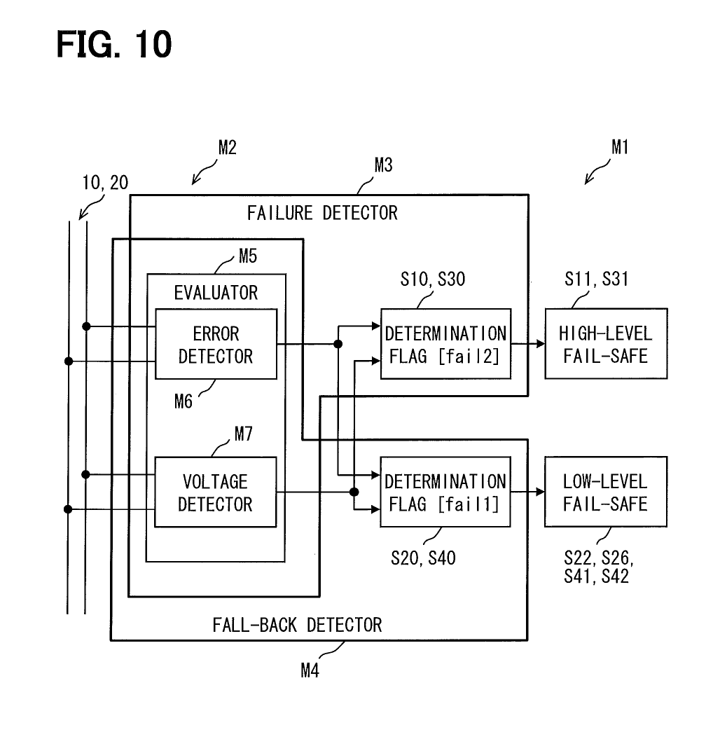

FIG. 10 shows a block diagram showings blocks of detectors and modules provided by the embodiment. The fail-safe control system M1 (31, 32, 33, 34, 35) is one of nodes on the data communication system M2. The fail-safe control system M1 is connected to the signal lines 10 and 20. The two signal lines 10 and 20 transmit signal by using the differential voltage signaling. The fail-safe control system M1 has a failure detector M3 which detects that the data communication system M2 is in failure state in which data communication is completely disabled, i.e., stopped. The fail-safe control system M1 has a fall-back detector M4 which detects that the data communication system M2 is in fall-back state in which data communication is performed by using a single signal line, when the other one of signal lines is damaged. The fail-safe control system M1 has a high-level fail-safe module S11 and S31 which perform a first fail-safe control that restricts function of the vehicle in response to a detection of the failure state by the failure detector M3. The fail-safe control system M1 has a low-level fail-safe module S22, S26, S41 and S42 which perform a second fail-safe control that is different from the first fail-safe control by the high-level fail-safe module. The failure detector M3, the fall-back detector M4, the high-level fail-safe module S11 and S31, and the low-level fail-safe module S22, S26, S41 and S42 may be provided in one of the controllers. Alternatively, the failure detector M3, the fall-back detector M4, the high-level fail-safe module S11 and S31, and the low-level fail-safe module S22, S26, S41 and S42 may be provided in two or more controllers in a distributed manner.

The failure detector M3 may have an evaluator M5 to evaluate communicating state of the data communication system M2, and a determination module S10 and S30 to determine result of evaluation by the evaluator M5. The fall-back detector M4 may have an evaluator M5 to evaluate communicating state of the data communication system M2, and a determination module S20 and S40 to determine result of evaluation by the evaluator M5. The determination modules S10, S30, S20, and S40 may be provided by using flags, such as the fail1 and fail2.

The evaluator M5 may be provided by one of an error detector M6 and a voltage detector M7. The error detector M6 detects at least one of the failure state and the fall-back state based on a frequency of error in data communication. The error detector M6 may be configured to identify normal state, the failure state, and the fall-back state. The voltage detector M7 detects at least one of the failure state and the fall-back state based on voltage levels on the signal lines 10 and 20, and combinations of the voltage levels. The voltage detector M7 may be configured to identify normal state, the failure state, and the fall-back state.

The first fail-safe control performed by the high-level fail-safe module S11 and S31 is designed to suppress disadvantage resulting from the failure state. One example of the first fail-safe control may restrict function of the vehicle heavily and substantially. One example of the first fail-safe control may suspend function of the vehicle completely. One example of the first fail-safe control may restrict driving function of the vehicle to the minimum level.

The second fail-safe control performed by the low-level fail-safe module S22, S26, S41, and S42 may be designed to make a user of the vehicle recognizes the fall-back state at least. One example of the second fail-safe control may be less restrictive than the first fail-safe control performed by the high-level fail-safe module S11 and S31. One example of the second fail-safe control may permit use of function of the vehicle. One example of the second fail-safe control may restrict the driving function of the vehicle to an intermediate level looser than the minimum level. The second fail-safe control makes the user to recognize the fall-back state while permitting use of the vehicle. One example of the second fail-safe control may include a warning control which generates warning signal to the user to show that it is in the fall-back state. The second fail-safe control is performed as a measure of precaution prior to the failure state. The first and second fail-safe control may be performed by restricting both the driving function and the other function of the vehicle.

### OTHER EMBODIMENTS

The present disclosure is not limited to the above-mentioned embodiments, but may be implemented by the following modification. In addition, the parts and components in the embodiments may be combined freely.

In the illustrated embodiment, CAN is used for the data communication system. Alternatively, the disclosure may be applied to a data communication system which uses a pair of signal lines and transmits data by using a differential voltage signaling. For example, FlexRay (Trademark), which enables faster multiplex communication, may be used. Moreover, for communication between ECUs which control a device with much data volume, such as a car navigation device, an audio device, a telephone, etc., MOST (Media Oriented System Transport), GVIF (Gigabit VideoInterFace), LVDS (Low Voltage Differential Signaling), etc. may be used.

In the illustrated embodiment, the high-level fail-safe control and the low-level fail-safe control are applied to one of the engine output torque control and the vehicle distance control. The high-level fail-safe control and the low-level fail-safe control may be applied to the other control, such as a brake control by the BR-ECU 35, operation control of an air bag, etc.

In the illustrated embodiment, both the low-level fail-safe control for restricting the engine output torque control and the vehicle distance control and the low-level fail-safe control for notifying the fall-back state to the user are performed. Alternatively, only one of the low-level fail-safe control for restricting and the low-level fail-safe control for notifying may be performed.

In the illustrated embodiment, the output of the engine, i.e., driving power source of the vehicle, is restricted, i.e., lowered, in the fail-safe control. In a case that an electric motor is a driving power source of the vehicle, the output of the electric motor may be restricted in the fail-safe control.

In the illustrated embodiment, the engine output is limited so that the engine output does not exceed the guard value. Therefore, no restriction is applied when the engine output is less than the guard value. Alternatively, the engine output may be restricted by lowering the engine output by a predetermined ratio. By setting the ratio in an appropriate value, it is possible to limit the engine output lower than the guard value.

Alternatively, the engine output may be restricted by limiting an input value, i.e., a target value, to the engine ECU 31 such as an operation amount of a gas pedal. Alternatively, the engine output may be restricted by limiting an internal control amount or a control command value, i.e., a command value to an actuator such as a fuel injector, based on a predetermined guard value. The internal control amount and the control command value are calculated based on the input value.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A fail-safe control system for a vehicular data communication system which uses differential voltage signaling on a pair of signal lines for connecting a plurality of controllers in a data communication manner, the fail-safe control system comprising:
a failure detector (S10, S30) which detects that data communication on the communication system is in failure state;
a fall-back detector (S20, S40) which detects that data communication on the communication system is in fall-back state in which data communication is performed by using a single signal line when the other signal line is damaged;
a high-level fail-safe module (S11, S31) which restricts function of the vehicle when the failure detector detects the failure state; and
a low-level fail-safe module (S22, S26, S41, S42) which restricts function of the vehicle with a different level of restriction or notifies the fall-back state to a user of the vehicle, when the fall-back detector detects the fall-back state.

2. The fail-safe control system in claim 1, wherein
the high-level fail-safe module restricts function of the vehicle in a more restrictive manner than that provided by the low-level fail-safe module.

3. The fail-safe control system in claim 1, wherein
the high-level fail-safe module and the low-level fail-safe module restrict driving performance of the vehicle.

4. The fail-safe control system in claim 3, wherein
the high-level fail-safe module restricts the driving performance of the vehicle in a more restrictive manner than that provided by the low-level fail-safe module.

5. The fail-safe control system in claim 3, wherein
the fall-back detector detects the fall-back state based on voltage levels on the signal lines.

6. The fail-safe control system in claim 3, wherein
the fall-back detector detects the fall-back state based on counted number of errors in data communication on the data communication system.

7. The fail-safe control system in claim 3, wherein
the high-level fail-safe module restricts driving of the vehicle by inhibiting drive of the vehicle or by inhibiting an acceleration of the vehicle, and wherein
the low-level fail-safe module enables driving of the vehicle while limiting output of a driving power source or target value of the output of the driving power source based on a guard value.
